(19) United States
(12) Patent Application Publication
(10) Pub. No.: US 2025/0293304 A1
(43) Pub. Date: Sep. 18, 2025

(54) SECONDARY BATTERY

(71) Applicant: MURATA MANUFACTURING CO., LTD., Kyoto (JP)

(72) Inventor: Masaki YAMAGAMI, Kyoto (JP)

(21) Appl. No.: 19/224,119

(22) Filed: May 30, 2025

Related U.S. Application Data
(63) Continuation of application No. PCT/JP2023/042550, filed on Nov. 28, 2023.

(30) Foreign Application Priority Data
Feb. 10, 2023 (JP) 2023-019473

(51) Int. Cl. H01M 10/0567

(52) U.S. Cl. CPC H01M 10/0567

(57) ABSTRACT

A positive electrode, a negative electrode, a separator, and an electrolytic solution are included, and the electrolytic solution contains an acetamide derivative represented by Formula (1) and lithium bis(fluorosulfonyl)imide:

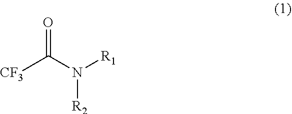

In Formula (1), R₁ and R₂ each independently represent an alkyl group or alkoxy group having one to five carbon atoms and optionally having a substituent, or a trimethylsilyl group, and R₁ and R₂ may be bonded to each other to form a fused ring.

### CROSS REFERENCE TO RELATED APPLICATIONS

The present application is a continuation of International Application No. PCT/JP2023/042550, filed on Nov. 28, 2023, which claims priority to Japanese Patent Application No. 2023-019473, filed on Feb. 10, 2023, the entire contents of which are incorporated herein by reference.

### BACKGROUND

The present application relates to a secondary battery.

In the secondary battery, lithium bis(fluorosulfonyl)imide (LiFSI) may be used as the electrolyte salt of the electrolytic solution. In this case, the electrolytic solution may corrode a metal such as aluminum used as the positive electrode current collector. Therefore, it is required to suppress corrosion of current collectors and the like due to LiFSI.

An asymmetric borate ester, an asymmetric phosphate ester, or the like is added to an electrolytic solution for the purpose of suppressing corrosion of current collectors and the like due to LiFSI.

### SUMMARY

The present application relates to a secondary battery.

A secondary battery that can be stably charged and discharged while suppressing corrosion of current collectors and the like using LiFSI as an electrolyte salt of an electrolytic solution is desired.

The present application has been made in view of the above problems, and an object thereof is to provide a secondary battery that can be stably charged and discharged while suppressing corrosion of current collectors and the like due to lithium bis(fluorosulfonyl)imide.

A secondary battery according to an aspect of the present application is a secondary battery including: a positive electrode; a negative electrode; a separator; and an electrolytic solution, in which the electrolytic solution contains an acetamide derivative represented by Formula (1) and lithium bis(fluorosulfonyl)imide:

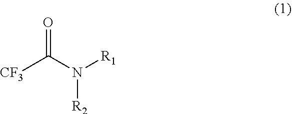

(In Formula (1), R₁ and R₂ each independently represent an alkyl group or alkoxy group having one to five carbon atoms and optionally having a substituent, or a trimethylsilyl group, and R₁ and R₂ may be bonded to each other to form a fused ring).

The present application can provide a secondary battery that can be stably charged and discharged while suppressing corrosion of current collectors and the like due to lithium bis(fluorosulfonyl)imide according to an embodiment.

### BRIEF DESCRIPTION OF THE FIGURES

FIG. 1 is a sectional view illustrating an example of a secondary battery according to the present embodiment.

FIG. 2 is an enlarged view of the region A in FIG. 1.

FIG. 3 is a cutaway view illustrating another example of the secondary battery according to the present embodiment.

FIG. 4 is a schematic view of a section taken along the line VI-VI of FIG. 3.

### DETAILED DESCRIPTION

Hereinafter, the present application will be described in further detail according to an embodiment. The present application is not limited by the embodiment.

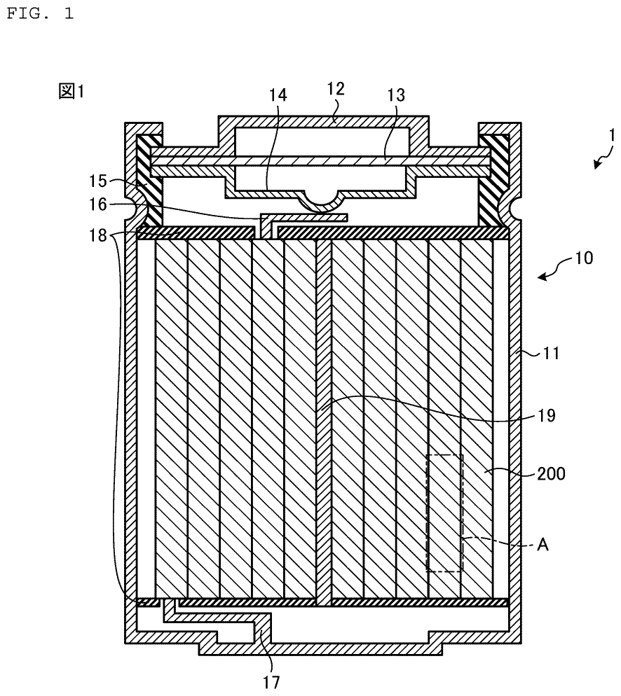

FIG. 1 is a sectional view illustrating an example of a secondary battery according to the present embodiment. A secondary battery 1 illustrated in FIG. 1 is a cylindrical lithium ion secondary battery. As illustrated in FIG. 1, the secondary battery 1 includes a casing 10 and an electrode assembly 200.

The casing 10 is a case that houses the electrode assembly 200 and an electrolytic solution (not shown) therein. The casing 10 includes a battery can 11, a lid 12, a heat sensitive resistance element 13, a safety valve mechanism 14, a gasket 15, a positive electrode lead 16, a negative electrode lead 17, a center pin 19, and insulating plates 18.

The battery can 11 is a cylindrical member including an end surface serving as the minus terminal of the secondary battery 1. That is, the battery can 11 is a cylinder in which one end surface is closed and the other end surface is opened. The battery can 11 is a conductor and is made of, for example, iron (Fe) plated with nickel (Ni).

The lid 12 is a disk-shaped member including a protrusion serving as the plus terminal of the secondary battery 1. The lid 12 is provided on the end surface on the opened side of the battery can 11. The lid 12 is made of a conductor and is made of, for example, the same material as that of the battery can 11.

Here, in the following description, the direction in which the cylindrical portion of the battery can 11 extends may be described as the length direction of the secondary battery 1. In the following description, the plus terminal of the secondary battery 1 refers to the protrusion of the lid 12, and the minus terminal of the secondary battery 1 refers to the closed end surface of the battery can 11.

The heat sensitive resistance element 13 is an element whose resistance increases due to temperature increase. The heat sensitive resistance element 13 is provided on the minus terminal side of the lid 12. When the temperature of the secondary battery 1 becomes high due to a short circuit or the like, the heat sensitive resistance element 13 has an increased resistance and limits the current.

The safety valve mechanism 14 is a mechanism whose shape changes according to the gas pressure in the casing 10. The safety valve mechanism 14 is provided on the minus terminal side of the heat sensitive resistance element 13. The safety valve mechanism 14 is electrically connected to the lid 12 via the heat sensitive resistance element 13. The safety valve mechanism 14 has a protrusion on the minus terminal side, and is in contact with the positive electrode lead 16 via the protrusion for electrical connection when the gas pressure is normal in the casing 10. On the other hand, when the gas pressure in the casing 10 increases, the protrusion of the safety valve mechanism 14 is reversed to the plus terminal side and separated from the positive electrode lead 16. The positive electrode lead 16 and the lid 12 are therefore electrically disconnected from each other.

The gasket 15 is an annular member that fixes the lid 12, the heat sensitive resistance element 13, and the safety valve mechanism 14 to the battery can 11. The gasket 15 is provided on the open end surface of the battery can 11. The gasket 15 brings the battery can 11 and the lid 12 into close contact with each other to make the inside of the casing 10 airtight. The gasket 15 is an insulator.

The positive electrode lead 16 is a terminal connected to a positive electrode 210 of the electrode assembly 200 described later. The positive electrode lead 16 is electrically connected to the lid 12 via the safety valve mechanism 14 and the heat sensitive resistance element 13. The positive electrode lead 16 is a conductor and is made of, for example, aluminum.

The negative electrode lead 17 is a terminal connected to a negative electrode 220 of the electrode assembly 200 described later. The negative electrode lead 17 is electrically connected to the battery can 11. The negative electrode lead 17 is a conductor and is made of, for example, nickel.

The insulating plates 18 are plate-like members having an insulation property. One insulating plate 18 is provided so as to cover the electrode assembly 200 described later on each of the plus terminal side of the secondary battery 1 and the minus terminal side of the secondary battery 1.

The center pin 19 is provided along the center axis of the electrode assembly 200. The center pin 19 is a linear member having a length in the length direction of the secondary battery 1. The material of the center pin 19 is not particularly limited, and is, for example, metal.

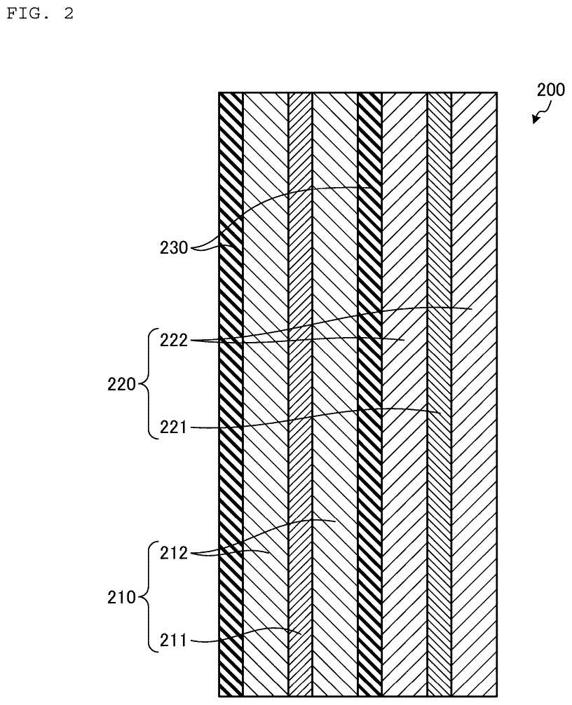

FIG. 2 is an enlarged view of the region A in FIG. 1. As shown in FIG. 2, the electrode assembly 200 includes the positive electrode 210, the negative electrode 220, and a separator 230. In the secondary battery 1, the electrode assembly 200 has a structure in which the positive electrode 210 and the negative electrode 220 are laminated with the separator 230 interposed therebetween. In the example of FIG. 1, the electrode assembly 200 is provided inside the battery can 11 and has a structure in which the electrode assembly is wound around the center pin 19. In other words, in the electrode assembly 200, the positive electrode 210, the negative electrode 220, and the separator 230 are laminated in the radial direction of the secondary battery 1 with the center pin 19 as the center. The electrode assembly 200 includes the positive electrode 210 and the negative electrode 220, each of which is a layered member for a charge-discharge reaction of the secondary battery according to the present embodiment.

The positive electrode 210 includes a positive electrode current collector layer 211 and a positive electrode active material layer 212. In the positive electrode 210, the positive electrode current collector layer 211 is laminated between the positive electrode active material layers 212.

The positive electrode current collector layer 211 is a conductor layer, and for example, an aluminum foil or the like can be used.

The positive electrode active material layer 212 is a layer containing a positive electrode active material. The positive electrode active material layer 212 contains a positive electrode active material, a binder, and a conductive aid. The positive electrode active material layer 212 is not limited to the materials described above, and may further contain, for example, a dispersant.

The positive electrode active material is preferably a lithium-containing compound such as a lithium-containing composite oxide and a lithium-containing phosphate compound. The lithium-containing composite oxide is an oxide containing lithium and one or more elements other than lithium as constituent elements. The lithium-containing composite oxide has, for example, a layered rock-salt type or spinel type crystal structure. Examples of the lithium-containing composite oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15} (Mn_{0.65}Ni_{0.22}Co_{0.13})O₂, and LiMn₂O₄. The lithium-containing phosphate compound is a phosphate compound containing lithium and one or more elements other than lithium as constituent elements. The lithium-containing phosphate compound has, for example, an olivine type crystal structure. Examples of the lithium-containing phosphate compound include LiFePO₄, LiMnPO₄, LiFe_{0.5}Mn_{0.5}PO₄, and LiFe_{0.3}Mn_{0.7}PO₄.

The binder contained in the positive electrode active material layer 212 may be an arbitrary material, and contains, for example, one or more of synthetic rubbers and polymer compounds. Examples of the synthetic rubbers include styrene-butadiene-based rubber, fluorine-based rubber, and ethylene propylene diene. Examples of the polymer compounds include polyvinylidene fluoride and a polyimide.

The conductive aid contained in the positive electrode active material layer 212 may be an arbitrary material, and contains, for example, carbon. Examples of the carbon include graphite, carbon black, acetylene black, and Ketjen black. The conductive aid is not limited thereto, and may be a metal material, a conductive polymer, or the like as long as the agent is a conductive material.

The negative electrode 220 includes a negative electrode current collector layer 221 and a negative electrode active material layer 222. In the negative electrode 220, the negative electrode current collector layer 221 is laminated between the negative electrode active material layers 222.

The negative electrode current collector layer 221 is a conductor, and for example, a copper foil or the like can be used.

The negative electrode active material layer 222 is a layer containing a negative electrode active material. The negative electrode active material layer 222 is not limited to be made of only the negative electrode active material, and may contain, for example, a conductive aid and a binder.

The negative electrode active material includes, for example, a material capable of occluding and releasing lithium, such as a carbon material, a metal, a metalloid, an alloy or a compound of silicon, and an alloy or a compound of tin (Sn).

Examples of the carbon material that can be used as the negative electrode active material include graphite, non-graphitizable carbon, and graphitizable carbon. More specifically, examples of the carbon material include pyrolytic carbons, cokes, glassy carbon fibers, organic polymer compound fired bodies, activated carbon, and carbon blacks. Examples of the cokes include pitch coke, needle coke, and petroleum coke. The organic polymer compound fired body is a substance obtained by firing a polymer compound such as a phenol resin and a furan resin at an appropriate temperature to carbonize.

Examples of the metal and the metalloid that can be used as the negative electrode active material include tin, lead (Pb), aluminum, indium (In), silicon, zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Of these, silicon, germanium, tin, and lead are preferable. In addition, silicon and tin are more preferable because of having a high ability to occlude and release lithium and allowing a high energy density.

Examples of the alloy of silicon that can be used as the negative electrode active material include alloys containing at least one from the group consisting of tin, nickel, copper (Cu), iron (Fe), cobalt (Co), manganese (Mn), zinc, indium, silver, titanium (Ti), germanium, bismuth, antimony, and chromium (Cr) as the second constituent element other than silicon. Examples of the compound of silicon that can be used as the negative electrode active material include a compound including oxygen (O) or carbon (C), and the compound may include the above-described second constituent element in addition to silicon.

Examples of the alloy of tin that can be used as the negative electrode active material include alloys including at least one from the group consisting of silicon, nickel, copper, iron, cobalt, manganese, zinc, indium, silver, titanium, germanium, bismuth, antimony, and chromium as the second constituent element other than tin. Examples of the compound of tin that can be used as the negative electrode active material include those including oxygen or carbon, and the compound of tin may include the above-mentioned second constituent elements in addition to tin.

The separator 230 is a membrane that insulates the positive electrode 210 from the negative electrode 220. The separator 230 is laminated between the positive electrode 210 and the negative electrode 220 so that the positive electrode 210 and the negative electrode 220 are not in direct contact with each other. The material of the separator 230 is preferably electrically stable, chemically stable against the positive electrode active material, the negative electrode active material, and the electrolytic solution, and has an insulating property. As the separator 230, for example, a layer including a polymer nonwoven fabric, a porous film, glass, or ceramic fibers can be used. The material of the separator 230 more preferably includes a porous polyolefin film. The separator 230 may be composed of a plurality of layers, and a composite of a porous polyolefin film and a heat-resistant film containing fibers of a polyimide, glass, or ceramic may be used.

The electrolytic solution is filled in a space surrounded by the insulating plates 18 and the battery can 11. For example, the electrolytic solution contains an electrolyte salt and a solvent for dissolving the electrolyte salt.

The electrolyte salt includes lithium bis(fluorosulfonyl)imide (LiN(SO₂F₂)₂). As a result, charge-discharge characteristics can be improved. The electrolyte salt may contain another electrolyte salt used as an electrolyte salt of a lithium ion battery. The mass of the other electrolyte salt is preferably 1/3 or less, more preferably 1/4 or less, with respect to the mass of lithium bis(fluorosulfonyl)imide (LiN(SO₂F₂)₂). For example, the other electrolyte salt is a light metal salt such as a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂).

The solvent contains an acetamide derivative represented by Formula (1). This makes it possible to suppress corrosion of the positive electrode current collector layer 211 and the like caused by lithium bis(fluorosulfonyl)imide.

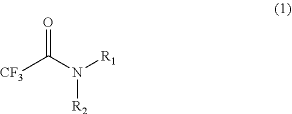

(In Formula (1), R₁ and R₂ each independently represent an alkyl group or alkoxy group having one to five carbon atoms and optionally having a substituent, or a trimethylsilyl group, and R₁ and R₂ may be bonded to each other to form a fused ring.)

The phrase “optionally having a substituent” means that it does not have a substituent or that a hydrogen group is substituted with one or more substituents. Examples of the substituent include a hydrocarbon group and a halogen group such as a fluorine group.

Examples of the compound represented by Formula (1) include compounds represented by Formulas (1-1) to (1-5).

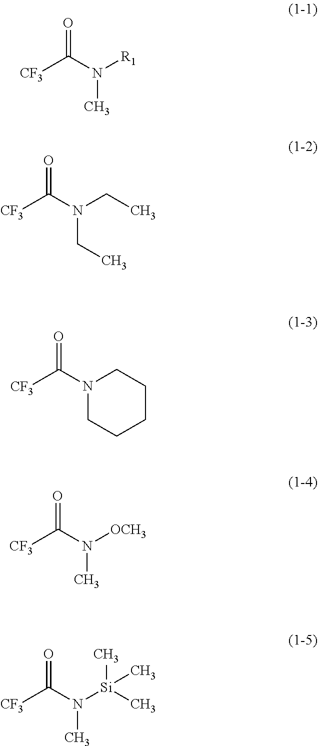

In the present embodiment, the molar ratio of the acetamide derivative to lithium bis(fluorosulfonyl)imide is two or more and four or less. Setting the molar ratio to two or more makes it possible to suppress corrosion of the positive electrode current collector layer 211 and the like caused by lithium bis(fluorosulfonyl)imide well. When the molar ratio is four or less, the viscosity of the electrolytic solution decreases, so that the discharging rate characteristics can be improved.

The solvent may contain another non-aqueous solvent used as an electrolyte salt of a lithium ion battery. The mass of the other non-aqueous solvent is preferably 1/3 or less, more preferably 1/4 or less, with respect to the mass of the acetamide derivative represented by Formula (1). The other non-aqueous solvents include esters, ethers, and the like. More specifically, the other non-aqueous solvents include a carbonic acid ester-based compound, a carboxylic acid ester-based compound, and a lactone-based compound. The carbonic acid ester-based compound is a cyclic carbonic acid ester, a chain carbonic acid ester, and the like. Specific examples of the cyclic carbonic acid ester include ethylene carbonate and propylene carbonate. Specific examples of the chain carbonic acid ester include dimethyl carbonate, diethyl carbonate, and ethyl methyl carbonate. The carboxylic acid ester-based compound is a chain carboxylic acid ester or the like. Specific examples of the chain carboxylic acid ester include methyl acetate, ethyl acetate, propyl acetate, methyl propionate, ethyl propionate, propyl propionate, methyl trimethylacetate, ethyl trimethylacetate, methyl butyrate, and ethyl butyrate. The lactone-based compound is a lactone or the like. Specific examples of the lactone include γ-butyrolactone and γ-valerolactone. Specific examples of the ethers include 1,2-dimethoxyethane, tetrahydrofuran, 1,3-dioxolane, and 1,4-dioxane. The ethers may be a compound in which some or all of hydrogen atoms are substituted with fluorine, such as 1,1,2-tetrafluoroethyl 2,2,2,3,3-tetrafluoropropyl ether.

The electrolytic solution may contain a substance other than the electrolyte salt and the solvent, such as an additive. The mass of the substance other than the electrolyte salt and the solvent is preferably 0.1 mass % or more and 20 mass % or less with respect to the mass of the additive of the electrolyte salt and the solvent.

The electrolytic solution preferably further contains, as additives, at least one of unsaturated cyclic carbonic acid esters such as vinylene carbonate, 4-methylene-1,3-dioxolan-2-one (methylene ethylene carbonate), and vinyl ethylene carbonate, and halogenated cyclic carbonic acid esters such as fluoroethylene carbonate (monofluoroethylene carbonate) and difluoroethylene carbonate. As a result, a coating film having high ion conductivity is generated at the interfaces between the positive electrode 210 and the negative electrode 220 and the electrolytic solution, so that the discharging rate characteristics can be further improved.

The additives are not limited to those described above, and other additives may be used. The other additives are not particularly limited, but may be specifically a sulfonic acid ester, a phosphoric acid ester, an acid anhydride, an isocyanate, or the like. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the isocyanate include hexamethylene diisocyanate.

The electrolytic solution preferably further contains a hydrofluoroether as an additive. Examples of the hydrofluoroether include 1,1,2,2-tetrafluoroethyl 2,2,3,3-tetrafluoropropyl ether. The viscosity of the electrolytic solution is thus reduced, and the ion conductivity of the electrolytic solution is improved, so that the discharging rate characteristics can be further improved.

Although the battery according to the present embodiment has been described above, the secondary battery according to the present embodiment is not limited to that illustrated in FIG. 1. Hereinafter, other examples will be described with reference to drawings, but configurations similar to those in FIGS. 1 and 2 are denoted by reference symbols, and description thereof will be omitted.

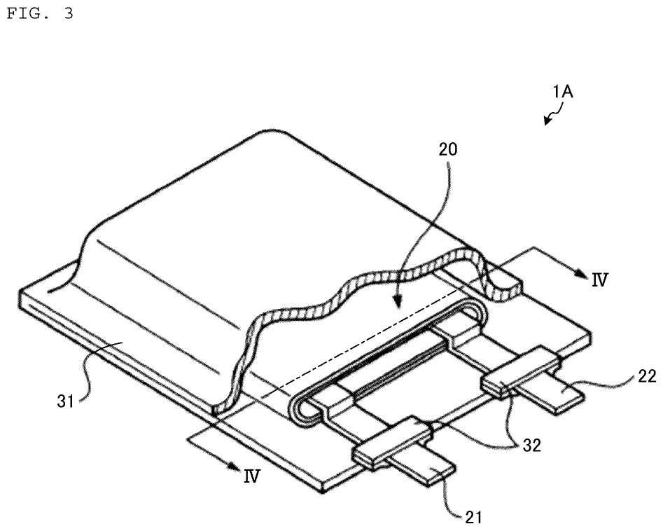

FIG. 3 is a cutaway view illustrating another example of the secondary battery according to the present embodiment. A secondary battery 1A illustrated in FIG. 3 is a laminate type lithium ion secondary battery. As shown in FIG. 3, the secondary battery 1A includes a battery element 20, an exterior member 31, and an adhesive member 32.

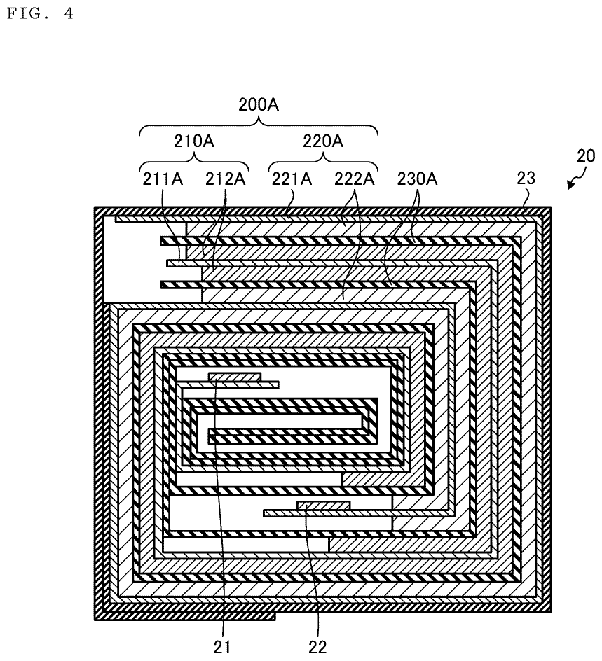

FIG. 4 is a schematic view of a section taken along the line VI-VI of FIG. 3. The battery element 20 is provided inside the exterior member 31. As shown in FIG. 4, the battery element 20 includes an electrode assembly 200A, a positive electrode lead 21, a negative electrode lead 22, and a protective member 23. The positive electrode lead 21 is a terminal drawn out from the inside of the battery element 20 to the outside of the exterior member 31. That is, the positive electrode lead 21 is a terminal serving as a plus terminal of the secondary battery 1A. In FIG. 4, the positive electrode lead 21 is provided near the center of the battery element 20. The negative electrode lead 22 is a terminal drawn out from the inside of the battery element 20 to the outside of the exterior member 31. That is, the negative electrode lead 22 is a terminal serving as a minus terminal of the secondary battery 1A. In FIG. 4, the negative electrode lead 22 is provided near the center of the battery element 20. The protective member 23 is a member that protects the outside of the battery element 20. The protective member 23 is provided so as to be wound around the electrode assembly 200A. The protective member 23 is, for example, an insulator tape.

The exterior member 31 is a case housing the battery element 20. The exterior member 31 includes an insulating layer, a metal layer, and an outermost layer. The exterior member 31 has a structure in which the insulating layer, the metal layer, and the outermost layer are stacked in this order from the inside, that is, from the side where the battery element 20 is provided, and the layers are bonded by lamination or the like. The insulating layer of the exterior member 31 includes, for example, a resin such as polyethylene, polypropylene, modified polyethylene, modified polypropylene, and a polyolefin resin containing ethylene or propylene as a monomer. As a result, the exterior member 31 can lower the moisture permeability of the secondary battery 1A and improve the airtightness. The metal layer of the exterior member 31 is a metal plate material or foil material of aluminum, stainless steel, nickel, iron, or the like. The outermost layer may be made of an arbitrary material, but is preferably made of a material having high strength against breakage, piercing, or the like, such as a resin similar to that of the insulating layer, and nylon.

The adhesive member 32 is a member to make the exterior member 31 airtight. The adhesive member 32 is provided between the exterior member 31, and the positive electrode lead 21 and the negative electrode lead 22. The material of the adhesive member 32 preferably has a close contact property to the positive electrode lead 21 and the negative electrode lead 22. For example, when the positive electrode lead 21 and the negative electrode lead 22 are each made of a metal material, a polyolefin resin such as polyethylene, polypropylene, modified polyethylene, and modified polypropylene is used as the adhesive member 32. As a result, the adhesive member 32 can keep the gap between the exterior member 31 and the positive electrode lead 21 and the gap between the exterior member 31 and the negative electrode lead 22 hermetic, so that the interior of the exterior member 31 can be made airtight.

In the example of FIG. 4, the electrode assembly 200A is a laminate for the charge-discharge reaction of the secondary battery according to the present embodiment. The electrode assembly 200A includes: a positive electrode 210A including a positive electrode current collector layer 211A and a positive electrode active material layer 212A; a negative electrode 220A including a negative electrode current collector layer 221A and a negative electrode active material layer 222A; and a separator 230A. The electrode assembly 200A has a structure in which the electrode assembly 200A is wound around the positive electrode lead 21 and the negative electrode lead 22, and the negative electrode current collector layer 221A, the negative electrode active material layer 222A, the separator 230A, the positive electrode active material layer 212A, the positive electrode current collector layer 211A, the positive electrode active material layer 212A, the separator 230A, and the negative electrode active material layer 222A are stacked in this order from the outside, namely, from the protective member 23 side. In the electrode assembly 200A, layers other than the negative electrode current collector layer 221A, the separator 230A, and the positive electrode current collector layer 211A are not provided in the vicinity of the positive electrode lead 21 and the negative electrode lead 22. With this structure, the positive electrode current collector layer 211A is connected to the positive electrode lead 21, and the negative electrode current collector layer 221A is connected to the negative electrode lead 22.

As described above, the secondary battery according to the present embodiment is a secondary battery including: a positive electrode; a negative electrode; a separator; and an electrolytic solution, in which the electrolytic solution contains an acetamide derivative represented by Formula (1) and lithium bis(fluorosulfonyl)imide.

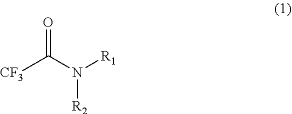

(In Formula (1), R₁ and R₂ each independently represent an alkyl group or alkoxy group having one to five carbon atoms and optionally having a substituent, or a trimethylsilyl group, and R₁ and R₂ may be bonded to each other to form a fused ring.)

This makes it possible to suppress corrosion of the current collector (positive electrode current collector layer 211) and the like caused by lithium bis(fluorosulfonyl)imide. Then, it is possible to provide a secondary battery that can be stably charged and discharged.

In a desirable aspect, the molar ratio of the acetamide derivative to lithium bis(fluorosulfonyl)imide is two or more and four or less. Setting the molar ratio to two or more makes it possible to suppress corrosion of the current collector and the like caused by lithium bis(fluorosulfonyl)imide well. When the molar ratio is four or less, the viscosity of the electrolytic solution decreases, so that the discharging rate characteristics can be improved.

In a desirable aspect, the electrolytic solution further contains at least one of an unsaturated cyclic carbonic acid ester and a halogenated cyclic carbonic acid ester. As a result, a coating film having high lithium ion conductivity is formed at the interfaces between the positive and negative electrodes and the electrolytic solution, so that the discharging rate characteristics can be further improved.

In a desirable aspect, the electrolytic solution further contains a hydrofluoroether. The viscosity of the electrolytic solution is thus reduced, so that the discharging rate characteristics can be further improved.

Hereinafter, examples according to the present application will be described according to an embodiment. It is to be noted that the present application is not limited to the following examples.

In the following description, lithium bis(fluorosulfonyl)imide is referred to as LiFSI, and a mixture obtained by mixing ethylene carbonate (EC) and propylene carbonate (PC) at a volume ratio of 1:1 is referred to as ECPC. Ch A to Ch E in the following description are as follows.

Ch A: a compound represented by Formula (1-1)

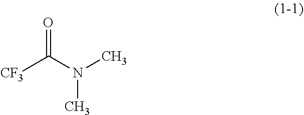

Ch B: a compound represented by Formula (1-2)

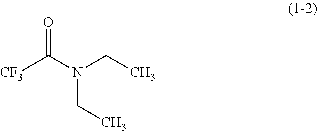

Ch C: a compound represented by Formula (1-3)

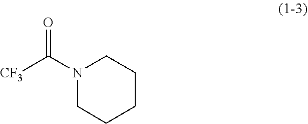 [SMILES: O=C(N1CCCCC1)C(F)(F)F]

Ch D: a compound represented by Formula (1-4)

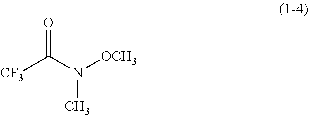

Ch E: a compound represented by Formula (1-5)

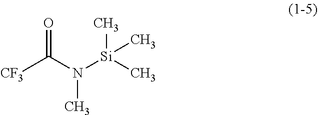

### Example 1-1

In Example 1-1, an aluminum foil, a polyethylene porous film, and lithium metal were stacked, and an electrolytic solution was injected to produce a battery for a metal corrosion evaluation test. In Example 1-1, a battery for a battery evaluation test was also produced by stacking a positive electrode, a polyethylene porous film as a separator, and a negative electrode and injecting an electrolytic solution. Here, the battery for a battery evaluation test was designed so as to have a designed capacity of 5 mAh.

In Example 1-1, for the electrolytic solution, Ch A was used as a solvent, and LiFSI was used as an electrolyte salt. The electrolytic solution according to Example 1-1 was prepared by mixing Ch A and LiFSI at a molar ratio of 3:1.

The positive electrode of the battery for a battery evaluation test was produced by the following method. First, 91 mass % of lithium nickelate (LiNiO₂) as a lithium-containing oxide as a positive electrode active material, 3 mass % of polyvinylidene fluoride as a binder, and 6 mass % of acetylene black as a conductive aid were mixed to provide a positive electrode mixture. Subsequently, the positive electrode mixture was put into N-methyl-2-pyrrolidone, which was an organic solvent, as a solvent, and then the mixture was stirred to prepare a paste-like positive electrode mixture slurry. Subsequently, the positive electrode mixture slurry was applied to both surfaces of a strip-shaped aluminum foil with a thickness of 12 μm as a positive electrode current collector with a coater. Finally, the positive electrode mixture slurry was dried to form positive electrode active material layers. The positive electrode active material layers were compression-molded using a roll press machine to produce a positive electrode.

The negative electrode of the battery for a battery evaluation test was produced by the following method. First, 93 mass % of graphite as a negative electrode active material and 7 mass % of polyvinylidene fluoride as a binder were mixed to prepare a negative electrode mixture. Subsequently, the negative electrode mixture was put into N-methyl-2-pyrrolidone, which was an organic solvent, as a solvent, and then the mixture was stirred to prepare a paste-like negative electrode mixture slurry. Subsequently, the negative electrode mixture slurry was applied to both surfaces of a strip-shaped copper foil with a thickness of 15 μm as a negative electrode current collector with a coater. The negative electrode mixture slurry was then dried to form negative electrode active material layers. Finally, the negative electrode active material layers were compression-molded using a roll press machine to produce a negative electrode.

The produced battery for a metal corrosion evaluation test was subjected to increase in voltage from the open circuit potential to 4.2 V at a rate of 1 mV per second using the aluminum foil as a working electrode, and after the voltage reached 4.2 V, subjected to potentiostatic electrolysis at 4.2 V for 5 hours, and the presence or absence of corrosion of the aluminum foil was evaluated. Specifically, when discoloration of the aluminum foil or leakage of the electrolytic solution occurred, it was judged that corrosion of the aluminum foil occurred.

As an initial charge-discharge test, the produced battery for a battery evaluation test was subjected to CCCV charging at a constant charging rate under the following conditions, charged at a charge control voltage after reaching the charge control voltage, the charging was finished when a current value decreased to charge cutoff, CC discharging was performed at a constant discharging rate, and the discharging was finished when the voltage reached a discharge cutoff voltage.
Charging rate: 0.05 C
Charge control voltage: 4.20 V
Charge cutoff: 0.01 C
Discharging rate: 0.05 C
Discharge cutoff voltage: 2.5 V

The initial charge-discharge test was performed on three batteries for a battery evaluation test. Here, for each battery for a battery evaluation test, when the capacity measured in the initial charge-discharge was 50% or more with respect to the theoretical capacity calculated from the mass of the active material, the battery for a battery evaluation test was judged to be capable of being charged and discharged, and when the capacity measured in the initial charge-discharge was less than 50% with respect to the theoretical capacity calculated from the mass of the active material, the battery for a battery evaluation test was judged to be incapable of being charged and discharged.

### Example 1-2

In Example 1-2, a battery for a metal corrosion evaluation test was produced and a metal corrosion evaluation test was conducted, and a battery for a battery evaluation test was produced and an initial charge-discharge test was conducted in the same manner as in Example 1-1 except that Ch B was used instead of Ch A as the solvent of the electrolytic solution.

### Example 1-3

In Example 1-3, a battery for a metal corrosion evaluation test was produced and a metal corrosion evaluation test was conducted, and a battery for a battery evaluation test was produced and an initial charge-discharge test was conducted in the same manner as in Example 1-1 except that Ch C was used instead of Ch A as the solvent of the electrolytic solution.

### Example 1-4

In Example 1-4, a battery for a metal corrosion evaluation test was produced and a metal corrosion evaluation test was conducted, and a battery for a battery evaluation test was produced and an initial charge-discharge test was conducted in the same manner as in Example 1-1 except that Ch D was used instead of Ch A as the solvent of the electrolytic solution.

### Example 1-5

In Example 1-5, a battery for a metal corrosion evaluation test was produced and a metal corrosion evaluation test was conducted, and a battery for a battery evaluation test was produced and an initial charge-discharge test was conducted in the same manner as in Example 1-1 except that Ch E was used instead of Ch A as the solvent of the electrolytic solution.

### Comparative Example 1-1

In Comparative Example 1-1, a battery for a metal corrosion evaluation test was produced and a metal corrosion evaluation test was conducted, and a battery for a battery evaluation test was produced and an initial charge-discharge test was conducted in the same manner as in Example 1-1 except that ECPC was used instead of Ch A as the solvent of the electrolytic solution.

The results of the metal corrosion evaluation tests and the initial charge-discharge tests according to Examples 1-1 to 1-5 and Comparative Example 1-1 are shown in Table 1.

TABLE 1

| | | Corrosion | Number of chargeable/ |
|---|---|---|---|
| | Solvent:Electrolyte | of | dischargeable batteries/ |
| | salt | aluminum | number of batteries for |
| | (molar ratio) | foil | battery evaluation test |
| Example 1-1 | Ch A:LiFSI = 3:1 | No | 3/3 |
| Example 1-2 | Ch B:LiFSI = 3:1 | No | 3/3 |
| Example 1-3 | Ch C:LiFSI = 3:1 | No | 3/3 |
| Example 1-4 | Ch D:LiFSI = 3:1 | No | 3/3 |
| Example 1-5 | Ch E:LiFSI = 3:1 | No | 3/3 |
| Comparative | ECPC:LiFSI = 3:1 | No | 0/3 |
| Example 1-1 | | | |

As shown in Table 1, in Examples 1-1 to 1-5, since the electrolytic solution containing any one of Ch A to Ch E was used, corrosion of the aluminum foil caused by LiFSI was suppressed, and all the three batteries subjected to the battery evaluation test were chargeable and dischargeable. As a result, the secondary batteries according to Examples 1-1 to 1-5 could be stably charged and discharged.

On the other hand, in Comparative Example 1-1, since the electrolytic solution containing ECPC was used, corrosion of the aluminum foil caused by LiFSI was suppressed, but all the three batteries subjected to the battery evaluation test were not chargeable or dischargeable. This is considered to be because in Comparative Example 1-1, since the electrolytic solution had a high viscosity, the separator and the like was not sufficiently impregnated with the electrolytic solution, or the ionic conductivity of the electrolytic solution was reduced.

### Example 2-1

In Example 2-1, a battery for a metal corrosion evaluation test was produced and a metal corrosion evaluation test was conducted, and a battery for a battery evaluation test was produced and an initial charge-discharge test was conducted in the same manner as in Example 1-1 except that Ch A and LiFSI were mixed at a molar ratio of 2:1.

### <<Discharging Rate Characteristic Evaluation Test>>

In Example 2-1, in addition to the initial charge-discharge test performed in Example 1-1, a discharging rate characteristic evaluation test was performed. In the discharging rate characteristic evaluation test, the discharging rate characteristics were evaluated by subjecting the battery for a battery evaluation test judged to be chargeable and dischargeable in the initial charge-discharge test to second to sixth charge-discharge described below.

In the second charge-discharge, CCCV charging was performed at a constant charging rate under the following conditions, charging was performed at a charge control voltage after reaching the charge control voltage, the charging was finished when a current value decreased to charge cutoff, CC discharging was performed at a constant discharging rate, and the discharging was finished when the voltage reached a discharge cutoff voltage. Here, the discharge capacity was measured at the second charge-discharge and was defined as a 0.2-C discharge capacity.
Charging rate: 0.2 C
Charge control voltage: 4.20 V
Charge cutoff: 0.05 C
Discharging rate: 0.2 C
Discharge cutoff voltage: 2.5 V

In the third to sixth charge-discharge, charging and discharging were performed under the same conditions as in the second charge-discharge test except that the charging rates were 0.5 C, 1.0 C, 2.0 C, and 5.0 C, respectively. Here, the discharge capacity was measured at the sixth charge-discharge and was defined as a 5-C discharge capacity.

Based on the measured 0.2-C discharge capacity and 5-C discharge capacity, a 5-C discharge capacity retention rate was calculated. Here, the 5-C discharge capacity retention rate is a ratio of the 5-C discharge capacity to the 0.2 discharge capacity. That is, when the 5-C discharge capacity retention rate is high, the discharge capacity can be increased also at a high discharging rate, so that it can be said that the discharging rate characteristics are improved.

### Example 2-2

In Example 2-2, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-1 except that Ch A and LiFSI were mixed at a molar ratio of 3:1. That is, the electrolytic solution according to Example 2-2 was the same as that of Example 1-1.

### Example 2-3

In Example 2-3, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-1 except that Ch A and LiFSI were mixed at a molar ratio of 4:1.

### Example 2-4

In Example 2-4, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-1 except that Ch A and LiFSI were mixed at a molar ratio of 5:1.

### Comparative Example 2-1

In Comparative Example 2-1, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-1 except that ECPC was used instead of Ch A as the solvent of the electrolytic solution and ECPC and LiFSI were mixed at a molar ratio of 2:1.

### Comparative Example 2-2

In Comparative Example 2-2, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-1 except that ECPC was used instead of Ch A as the solvent of the electrolytic solution and ECPC and LiFSI were mixed at a molar ratio of 3:1. That is, the electrolytic solution according to Comparative Example 2-2 was the same as that of Comparative Example 1-1.

### Comparative Example 2-3

In Comparative Example 2-3, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-1 except that ECPC was used instead of Ch A as the solvent of the electrolytic solution and ECPC and LiFSI were mixed at a molar ratio of 4:1.

### Comparative Example 2-4

In Comparative Example 2-4, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-1 except that ECPC was used instead of Ch A as the solvent of the electrolytic solution and ECPC and LiFSI were mixed at a molar ratio of 5:1.

The results of the metal corrosion evaluation tests and the battery evaluation tests according to Examples 2-1 to 2-4 and Comparative Examples 2-1 to 2-4 are shown in Table 2.

TABLE 2

| | | | Number of | |
|---|---|---|---|---|
| | | | chargeable/ | |
| | | | dischargeable | |
| | | | batteries/ | 5-C |
| | | Corrosion | number of | discharge |
| | Solvent:Electrolyte | of | batteries for | capacity |
| | salt | aluminum | battery | retention |
| | (molar ratio) | foil | evaluation test | rate (%) |
| Example | Ch A:LiFSI = 2:1 | No | 3/3 | 20.0 |
| 2-1 | | | | |
| Example | Ch A:LiFSI = 3:1 | No | 3/3 | 55.9 |
| 2-2 | | | | |
| Example | Ch A:LiFSI = 4:1 | No | 3/3 | 33.0 |
| 2-3 | | | | |
| Example | Ch A:LiFSI = 5:1 | No | 3/3 | 7.0 |
| 2-4 | | | | |
| Compar- | ECPC:LiFSI = 2:1 | No | 0/3 | — |
| ative | | | | |
| Example | | | | |
| 2-1 | | | | |
| Compar- | ECPC:LiFSI = 3:1 | No | 0/3 | — |
| ative | | | | |
| Example | | | | |
| 2-2 | | | | |
| Compar- | ECPC:LiFSI = 4:1 | No | 1/3 | 5.7 |
| ative | | | | |
| Example | | | | |
| 2-3 | | | | |
| Compar- | ECPC:LiFSI = 5:1 | Yes | 0/3 | — |
| ative | | | | |
| Example | | | | |
| 2-4 | | | | |

As shown in Table 2, in Examples 2-1 to 2-4, since the electrolytic solution containing Ch A was used, corrosion of the aluminum foil caused by LiFSI was suppressed, and all the three batteries subjected to the battery evaluation test were chargeable and dischargeable. As a result, the secondary batteries according to Examples 2-1 to 2-4 could be stably charged and discharged.

On the other hand, in Comparative Examples 2-1 and 2-2, since ECPC was contained, corrosion of the aluminum foil caused by LiFSI was suppressed, but all the three batteries subjected to the battery evaluation test were not chargeable or dischargeable. This is considered to be because in Comparative Examples 2-1 and 2-2, since the electrolytic solution had a high viscosity, the separator and the like was not sufficiently impregnated with the electrolytic solution, or the ionic conductivity of the electrolytic solution was reduced.

In Comparative Example 2-3, since ECPC was contained, corrosion of the aluminum foil caused by LiFSI was suppressed, but two out of the three batteries subjected to the battery evaluation test were not chargeable or dischargeable. As a result, the secondary batteries according to Comparative Example 2-3 could not be stably charged and discharged. This is considered to be because in Comparative Example 2-3, since the viscosity of the electrolytic solution was not sufficiently reduced, it became difficult for the separator and the like to be impregnated with the electrolytic solution, or the ionic conductivity of the electrolytic solution was reduced.

In Comparative Example 2-4, since the concentration of ECPC with respect to LiFSI was low, corrosion of the aluminum foil caused by LiFSI was not suppressed, and all the three batteries subjected to the battery evaluation test were not chargeable or dischargeable.

As shown in Table 2, in Examples 2-1 to 2-3, since the molar ratio of Ch A to LiFSI was two or more and four or less, the 5-C discharge capacity retention rate was improved as compared with Example 2-4 in which the molar ratio was more than four. In Example 2-3, since the electrolytic solution containing Ch A was used, the 5-C discharge capacity retention rate was improved as compared with Comparative Example 2-3 in which the molar concentration of LiFSI in the electrolytic solution was the same.

### Example 3-1

Example 3-1 is a same example as Example 2-2. That is, in Example 3-1, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-2 without mixing an additive to the electrolytic solution according to Example 2-2.

### Example 3-2

In Example 3-2, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-2 except that 1 mass % of vinylene carbonate (VC) was mixed as an additive to the electrolytic solution according to Example 2-2.

### Example 3-3

In Example 3-3, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-2 except that 1 mass % of fluoroethylene carbonate (FEC) was mixed as an additive to the electrolytic solution according to Example 2-2.

### Example 3-4

In Example 3-4, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-2 except that 1 mass % of 4-methylene-1,3-dioxolan-2-one (MDO) was mixed as an additive to the electrolytic solution according to Example 2-2.

The results of the metal corrosion evaluation tests and the battery evaluation tests according to Examples 3-1 to 3-4 are shown in Table 3.

TABLE 3

| | | | | | | 5-C |
|---|---|---|---|---|---|---|
| | | | | Corrosion | Number of chargeable/ | discharge |
| | | Additive | | of | dischargeable batteries/ | capacity |
| | Solvent:Electrolyte | | Amount | aluminum | number of batteries for | retention |
| | salt (molar ratio) | Type | (mass %) | foil | battery evaluation test | rate (%) |
| Example | Ch A:LiFSI = 3:1 | Absent | — | No | 3/3 | 55.9 |
| 3-1 | | | | | | |
| Example | Ch A:LiFSI = 3:1 | VC | 1 | No | 3/3 | 56.1 |
| 3-2 | | | | | | |
| Example | Ch A:LiFSI = 3:1 | FEC | 1 | No | 3/3 | 56.3 |
| 3-3 | | | | | | |
| Example | Ch A:LiFSI = 3:1 | MDO | 1 | No | 3/3 | 56.2 |
| 3-4 | | | | | | |

As shown in Table 3, in Examples 3-1 to 3-4, corrosion of the aluminum foil caused by LiFSI was suppressed, and all the three batteries subjected to the battery evaluation test were chargeable and dischargeable. As a result, the secondary batteries according to Examples 3-1 to 3-4 could be stably charged and discharged.

As shown in Table 3, in Examples 3-2 to 3-4, since the electrolytic solution obtained by adding VC, FEC, or MDO to the electrolytic solution according to Example 2-2 was used, the 5-C discharge capacity retention rate was improved as compared with Example 3-1 using the same electrolytic solution as the electrolytic solution according to Example 2-2. This is considered to be because an unsaturated cyclic carbonic acid ester or a halogenated cyclic carbonic acid ester was added to the electrolytic solution, so that a coating film having high ion conductivity was formed at the interface between the positive and negative electrodes and the electrolytic solution, and the interface resistance was reduced.

### Example 4-1

Example 4-1 is a same example as Example 2-2. That is, in Example 4-1, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-2 without mixing an additive to the electrolytic solution according to Example 2-2.

### Example 4-2

In Example 4-2, a battery for a metal corrosion evaluation test was produced and a metal corrosion evaluation test was conducted, and a battery for a battery evaluation test was produced and an initial charge-discharge test and a discharging rate characteristic evaluation test were conducted in the same manner as in Example 2-2 except that 10 mass % of 1,1,2,2-tetrafluoroethyl 2,2,3,3-tetrafluoropropyl ether (TTE) was mixed as an additive to the electrolytic solution according to Example 2-2.

The results of the metal corrosion evaluation tests and the battery evaluation tests according to Examples 4-1 and 4-2 are shown in Table 4.

TABLE 4

| | | | | | | 5-C |
|---|---|---|---|---|---|---|
| | | | | Corrosion | Number of chargeable/ | discharge |
| | | Additive | | of | dischargeable batteries/ | capacity |
| | Solvent:Electrolyte | | Amount | aluminum | number of batteries for | retention |
| | salt (molar ratio) | Type | (mass %) | foil | battery evaluation test | rate (%) |
| Example | Ch A:LiFSI = 3:1 | Absent | — | No | 3/3 | 55.9 |
| 4-1 | | | | | | |
| Example | Ch A:LiFSI = 3:1 | TTE | 10 | No | 3/3 | 58.0 |
| 4-2 | | | | | | |

As shown in Table 4, in Examples 4-1 and 4-2, corrosion of the aluminum foil caused by LiFSI was suppressed, and all the three batteries subjected to the battery evaluation test were chargeable and dischargeable.

As a result, the secondary batteries according to Examples 4-1 and 4-2 could be stably charged and discharged.

As shown in Table 4, in Example 4-1, since the electrolytic solution obtained by adding TTE to the electrolytic solution according to Example 2-2 was used, the 5-C discharge capacity retention rate was improved as compared with Example 4-1 using the same electrolytic solution as the electrolytic solution according to Example 2-2. This is considered to be because the addition of hydrofluoroether to the electrolytic solution decreased the viscosity of the electrolytic solution and improved the ionic conductivity.

It is to be noted that the embodiment described above is intended to facilitate understanding of the present application, but not intended to construe the present application in any limited way. The present application can be modified or improved without departing from the gist thereof, and equivalents thereof are also included in the present application.

The present application can have the following aspects according to an embodiment.

<1>

A secondary battery including: a positive electrode; a negative electrode; a separator; and an electrolytic solution, in which
the electrolytic solution contains an acetamide derivative represented by Formula (1) and lithium bis(fluorosulfonyl)imide:

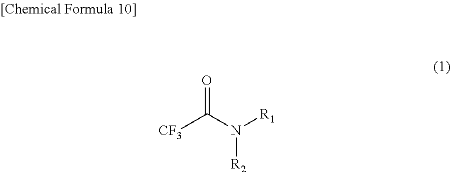

(In Formula (1), R₁ and R₂ each independently represent an alkyl group or alkoxy group having one to five carbon atoms and optionally having a substituent, or a trimethylsilyl group, and R₁ and R₂ may be bonded to each other to form a fused ring).
<2>

The secondary battery according to <1>, in which a molar ratio of the acetamide derivative to lithium bis(fluorosulfonyl)imide is two or more and four or less.

<3>

The secondary battery according to <1> or <2>, in which the electrolytic solution further contains at least one of an unsaturated cyclic carbonic acid ester and a halogenated cyclic carbonic acid ester.

<4>

The secondary battery according to any one of <1> to <3>, in which the electrolytic solution further contains a hydrofluoroether.

### DESCRIPTION OF REFERENCE SYMBOLS

1, 1A: Secondary battery
10: Casing
11: Battery can
12: Lid
13: Heat sensitive resistance element
14: Safety valve mechanism
15: Gasket
16: Positive electrode lead
17: Negative electrode lead
18: Insulating plate
19: Center pin
20: Battery element
21: Positive electrode lead
22: Negative electrode lead
23: Protective member
31: Exterior member
32: Adhesive member
200, 200A: Electrode assembly
210, 210A: Positive electrode
211, 211A: Positive electrode current collector layer
212, 212A: Positive electrode active material layer
220, 220A: Negative electrode
221, 221A: Negative electrode current collector layer
222, 222A: Negative electrode active material layer
230, 230A: Separator

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode;
a separator; and
an electrolytic solution, wherein
the electrolytic solution contains an acetamide derivative represented by Formula (1) and lithium bis(fluorosulfonyl)imide: 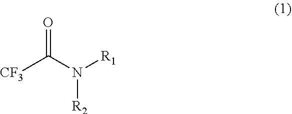
in Formula (1), R₁ and R₂ each independently represent an alkyl group or alkoxy group having one to five carbon atoms and optionally having a substituent, or a trimethylsilyl group, and R₁ and R₂ are optionally bonded to each other to form a fused ring.

2. The secondary battery according to claim 1, wherein a molar ratio of the acetamide derivative to lithium bis(fluorosulfonyl)imide is two or more and four or less.

3. The secondary battery according to claim 1, wherein the electrolytic solution further contains at least one of an unsaturated cyclic carbonic acid ester and a halogenated cyclic carbonic acid ester.

4. The secondary battery according to a claim 1, wherein the electrolytic solution further contains a hydrofluoroether.
